(19) United States
(12) Patent Application Publication
(10) Pub. No.: US 2026/0257252 A1
(43) Pub. Date: Sep. 3, 2026

(54) Protective Enclosure for a Wireless Earbud Charging Case with Integrated Cleaning Tool

(71) Applicant: Subodh Nimkar, Bothell, WA (US)

(72) Inventor: Subodh Nimkar, Bothell, WA (US)

(21) Appl. No.: 19/652,694

(22) Filed: Apr. 20, 2026

Related U.S. Application Data
(60) Provisional application No. 63/983,886, filed on Feb. 16, 2026.

(51) Int. Cl. B08B 9/00; E05C 19/16; H02J 7/70

(52) U.S. Cl. CPC B08B 9/00; E05C 19/16; H02J 7/731

(57) ABSTRACT

A protective enclosure for a wireless earbud charging case includes a body defining an internal cavity and a lid movable between open and closed positions. A compartment is formed within the body between an outer surface and an inner surface, the compartment being configured to receive a removable cleaning tool. The cleaning tool includes a body, and a cleaning tip configured to remove debris from an earbud. The cleaning tool may be retained within the compartment by one or more retention mechanisms, including magnetic coupling, frictional engagement, and mechanical retention. In some embodiments, a portion of the cleaning tool protrudes from the compartment and is received within a corresponding compartment of the lid when the lid is closed. Magnetic elements may be arranged such that opening of the lid causes the cleaning tool to be dislodged from the compartment to facilitate access.

### CROSS REFERENCE TO RELATED APPLICATIONS

This application claims the benefit of and priority to U.S. Provisional

Patent Application No. 63/983,886, filed on Feb. 16, 2026, the entire contents of which are hereby incorporated by reference in their entirety.

### FIELD OF DISCLOSURE

The present disclosure relates generally to protective enclosures for wireless earbud charging cases, and more particularly to enclosures incorporating integrated cleaning tools.

### BACKGROUND

Wireless earbuds and corresponding charging cases have become widely used for personal audio applications. These devices are frequently carried in pockets, bags, and other environments where they are exposed to dust, lint, and debris. As a result, accumulation of debris within earbud openings and charging interfaces can negatively impact performance, hygiene, and user experience.

Conventional protective enclosures for wireless earbud charging cases are designed primarily to protect the charging case from physical damage and environmental exposure. However, such enclosures generally do not address the need for convenient and accessible cleaning of the earbuds or charging interfaces. Users are often required to carry separate cleaning tools, which may be easily misplaced or unavailable when needed.

In some instances, cleaning tools may be provided as separate accessories. However, these tools are not typically integrated with the protective enclosure, resulting in inconvenience and reduced likelihood of regular maintenance. Additionally, existing storage solutions for accessories do not provide secure retention, ease of access, or coordinated interaction between storage components and the enclosure structure.

Accordingly, there remains a need for an improved protective enclosure for wireless earbud charging cases that incorporates a cleaning tool in a manner that provides secure retention, convenient accessibility, and enhanced functionality, while maintaining a compact and integrated design.

### SUMMARY

The present disclosure provides a protective enclosure for a wireless earbud charging case that incorporates an integrated cleaning tool configured for secure retention and convenient access. The protective enclosure includes a body defining an internal cavity for receiving the charging case and a lid movably coupled to the body between open and closed positions. The enclosure further includes a compartment formed within the body between an outer surface and an inner surface, the compartment being configured to house a removable cleaning tool.

In some embodiments, the cleaning tool includes a body and a cleaning tip configured to remove debris from an earbud. The cleaning tip may include a porous, compressible material for cleaning delicate surfaces or a rigid protruding tip for dislodging debris. The cleaning tool may be partially exposed to enable manual engagement and may interact with a corresponding compartment in the lid when the lid is in the closed position.

In certain embodiments, the cleaning tool is retained within the compartment by one or more retention mechanisms, including magnetic coupling, mechanical retention using a pin or latch, and frictional engagement with one or more walls of the compartment. In some embodiments, a compressible outer surface of the cleaning tool or a housing associated with the cleaning tool deforms upon insertion to enhance frictional retention.

In further embodiments, the cleaning tool and the lid may include cooperating magnetic elements configured such that opening of the lid causes the cleaning tool to be dislodged from the compartment, thereby facilitating user access. In some configurations, the cleaning tool or an associated housing may form a portion of the outer surface and a middle surface of the enclosure body when positioned within the compartment, thereby providing a substantially continuous exterior surface.

In additional embodiments, the enclosure may include a hinged door formed in the outer surface that permits access to the cleaning tool independently of the lid, allowing removal of the cleaning tool while the lid remains closed.

The present disclosure also provides methods of storing and accessing a cleaning tool within a protective enclosure, including inserting the cleaning tool into the compartment, retaining the cleaning tool using one or more retention mechanisms, and accessing the cleaning tool upon opening of the lid or through an independently accessible door.

### BRIEF DESCRIPTION OF DRAWINGS

FIG. 1 is a perspective view, a semi-transparent frontal view, and bottom plan view of a protective enclosure for a wireless earbud charging case, illustrating a cleaning tool disposed within a compartment of the protective enclosure body.

FIG. 2 is a perspective view, a semi-transparent frontal view, and bottom plan view of an embodiment of the protective enclosure illustrating a pin-based retention mechanism configured to secure the cleaning tool within the compartment.

FIG. 3 is a perspective view, a semi-transparent frontal view, and bottom plan view of an embodiment of the protective enclosure illustrating a hinged door formed in an outer surface of the protective enclosure body for accessing the cleaning tool.

FIG. 4 is a perspective view, a semi-transparent frontal view, and bottom plan view of an embodiment of the protective enclosure illustrating frictional retention of the cleaning tool within the compartment and magnetic coupling between the cleaning tool and a lid.

FIG. 5 is a perspective view, a semi-transparent frontal view, and bottom plan view of an embodiment of the protective enclosure illustrating a housing of the cleaning tool forming a continuous portion of an outer surface and a middle surface of the protective enclosure body.

### DETAILED DESCRIPTION

The foregoing description is provided for illustrative purposes only and is not intended to be limiting, and modifications and variations may be made without departing from the scope of the appended claims. As used herein, the terms “comprising,” “including,” and “having” are open-ended and indicate that additional elements or features may be present, and the terms “a,” “an,” and “the” include plural referents unless the context clearly indicates otherwise. The term “configured to” refers to structure that is capable of performing the recited function and is not intended to invoke 35 U.S.C. § 112(f) unless explicitly recited using “means for” or “step for.” Relative terms such as “outer,” “inner,” and “middle” are used for descriptive convenience and do not require a particular orientation unless expressly stated. As used herein, “rigid” refers to a structure that substantially maintains its shape under forces encountered during intended use, and “compressible” refers to a structure capable of deforming under applied force and returning toward its original shape. Where components are described as being “coupled,” “engaged,” or “connected,” such relationships may include direct or indirect interaction and may be mechanical, magnetic, frictional, or otherwise. Features described in connection with one embodiment may be combined with features of other embodiments unless expressly stated otherwise, and individual features may be omitted or modified without departing from the scope of the claims. No language in this specification should be interpreted as an admission that any particular feature, structure, or element is prior art, and the scope of the invention is defined by the appended claims and their equivalents.

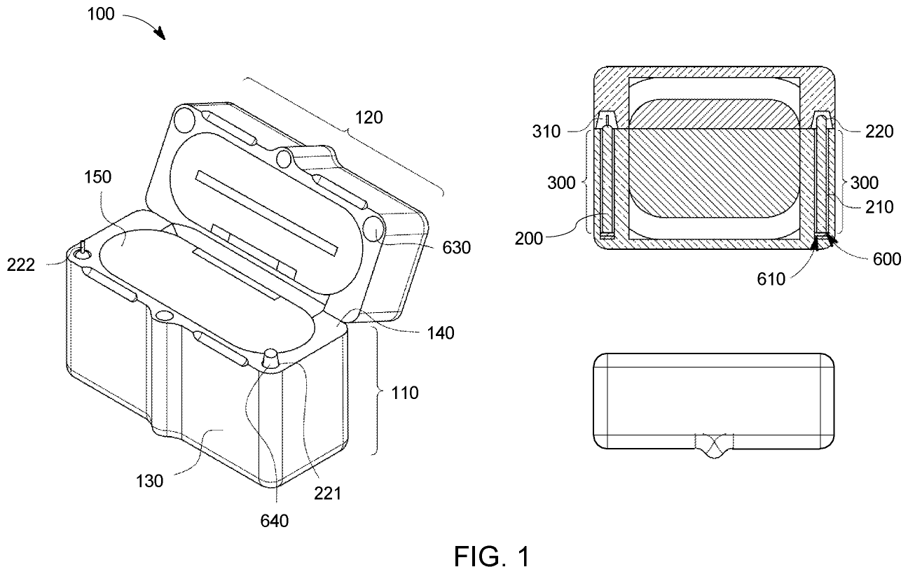

Referring to FIG. 1, a protective enclosure 100 for a wireless earbud charging case is illustrated. The protective enclosure 100 includes a protective enclosure body 110 defining an internal cavity sized and shaped to receive the wireless earbud charging case. The internal cavity is at least partially defined by an inner surface 150, which is configured to engage an exterior surface of the wireless earbud charging case to retain and stabilize the charging case within the protective enclosure 100.

The protective enclosure 100 further includes a lid 120 movably coupled to the protective enclosure body 110, for example via a hinge, such that the lid 120 is configured to transition between an open position and a closed position. In the closed position, the lid 120 cooperates with the protective enclosure body 110 to enclose the wireless earbud charging case within the internal cavity. In some embodiments, at least one retention feature may be provided to secure the wireless earbud charging case within the internal cavity when the lid 120 is in the closed position, the retention feature including a coupling mechanism between the lid 120 and the protective enclosure body.

As further shown in FIG. 1, the protective enclosure 100 comprises an outer surface 130, a middle surface 140, and the inner surface 150. The outer surface 130 defines an exterior boundary of the protective enclosure 100, while the inner surface 150 defines the internal cavity. The middle surface 140 is positioned between the outer surface 130 and the inner surface 150, and at least partially defines one or more internal compartments.

In the illustrated embodiment, a compartment 300 is formed within the protective enclosure body 110 between the outer surface 130 and the inner surface 150, and is at least partially defined by the middle surface 140. The compartment 300 is configured to house a removable cleaning tool 200.

The cleaning tool 200 includes a cleaning tool body 210 and a cleaning tool tip 220. In some embodiments, the cleaning tool tip 220 may be selected from multiple configurations. For example, in one embodiment, the cleaning tool may include a porous, compressible tip 221 formed of a material such as foam, sponge, or elastomeric material, configured to remove debris from an earbud without damaging sensitive components. In another embodiment, the cleaning tool may include a rigid protruding tip 222 configured to dislodge debris from an earbud, wherein the rigid protruding tip may include a spike configured to remove compacted earwax or particulate matter. In some embodiments, the cleaning tool 200 may be interchangeable, such that different tip types may be removably coupled to the cleaning tool body 210.

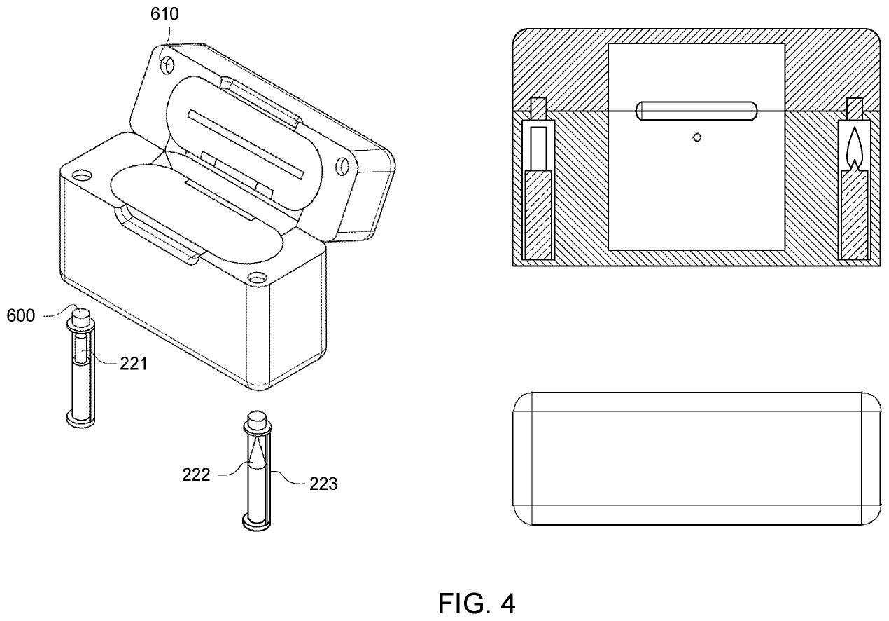

In certain embodiments, the cleaning tool 200 may be at least partially received within a cleaning tool supporting housing 223 as shown in FIG. 4, which may be configured to surround or support the cleaning tool body 210. The housing 223 may provide structural support, ergonomic handling, or integration with the protective enclosure body 110, as described further below.

As shown in FIG. 1, a portion of the cleaning tool 200 may protrude from an opening of the compartment 300, enabling manual engagement by a user. In some embodiments, the lid 120 may include a compartment 310 configured to receive the protruding portion of the cleaning tool 200 when the lid 120 is in the closed position. This arrangement allows the cleaning tool 200 to be partially captured between the protective enclosure body 110 and the lid 120 when closed.

In certain embodiments, the cleaning tool 200 may be retained within the compartment 300 via magnetic coupling. For example, the cleaning tool body 210 may include a first magnet 600, and the compartment 300 may include a second magnet 610 positioned to magnetically couple with the first magnet 600 to secure the cleaning tool 200 within the compartment 300.

In further embodiments, the lid 120 may include a third magnet 630, and the cleaning tool tip 220 or a protruding portion of the cleaning tool 200 may include a fourth magnet 640. The third magnet 630 and the fourth magnet 640 may be configured to magnetically couple when the protruding portion of the cleaning tool 200 is received within the compartment 310 of the lid 120. In some embodiments, the magnetic coupling force between the third magnet 630 and the fourth magnet 640 may be greater than the magnetic coupling force between the first magnet 600 and the second magnet 610, such that opening of the lid 120 causes the cleaning tool 200 to be dislodged from the compartment 300 of the protective enclosure body 110 and to follow the motion of the lid 120. In some embodiments, the relative magnetic coupling forces may be controlled by selection of magnet size, material, shape, spacing, and positioning within the respective components. For example, the third magnet 630 and the fourth magnet 640 may have a greater magnetic strength, larger surface area, or closer proximity relative to the first magnet 600 and the second magnet 610, such that the magnetic coupling force between the third magnet 630 and the fourth magnet 640 exceeds that between the first magnet 600 and the second magnet 610. In this manner, upon opening of the lid 120, the stronger magnetic coupling between the third and fourth magnets causes the cleaning tool 200 to disengage from the compartment 300 and move with the lid 120.

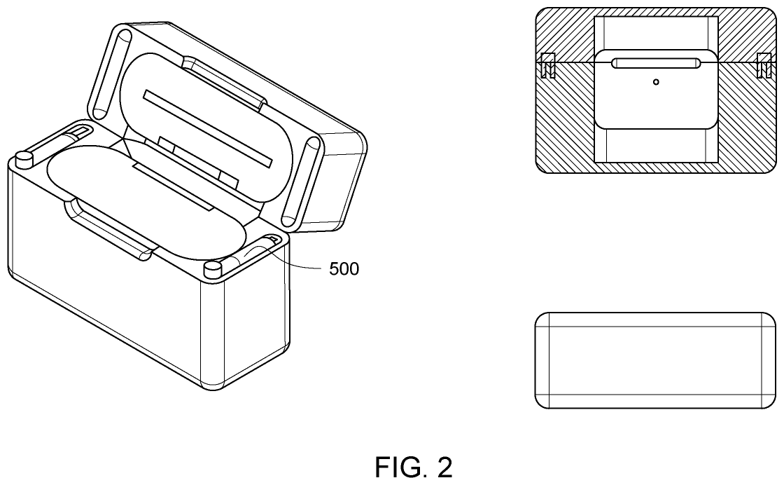

As illustrated in FIG. 2, the compartment 300 may further include one or more retention mechanisms configured to selectively secure the cleaning tool 200 within the compartment 300 and resist unintended removal. For example, a pin 500 may be provided, which may be configured to extend across an opening of the compartment 300 and overlie at least a portion of the cleaning tool 200 to prevent unintended removal. The pin 500 may be movably coupled to the protective enclosure body 110, for example via a latch or hinge, and may be selectively positioned between open and closed positions. In certain embodiments, the pin 500 may engage a corresponding recess or retention feature to maintain the pin in a closed position.

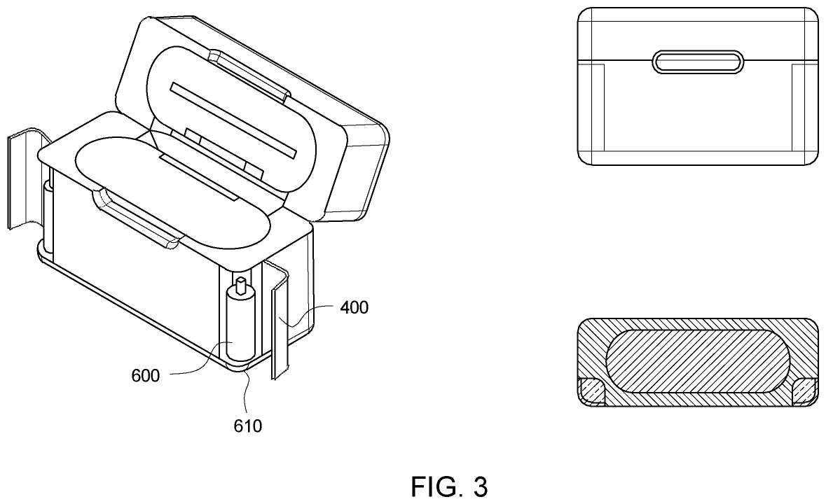

As illustrated in FIG. 3, the protective enclosure 100 may include a door 400 formed on the outer surface 130, the door 400 being movable between an open position and a closed position. When the door 400 is in the open position, the compartment 300 may be exposed to permit removal of the cleaning tool 200. In certain embodiments, the door 400 may be accessible when the lid 120 is in the closed position, thereby enabling access to the cleaning tool 200 independently of opening the lid 120.

As illustrated in FIG. 3, in some embodiments, the cleaning tool 200, and particularly the cleaning tool supporting housing 223, may be configured to be flush with and form a continuous portion of the outer surface 130 and the middle surface 140 of the protective enclosure body 110 when the cleaning tool 200 is received within the compartment 300. Upon removal of the cleaning tool 200, a corresponding opening is exposed in the outer surface 130 and the middle surface 140, thereby providing access to the compartment 300.

As illustrated in FIG. 4, in some embodiments, the cleaning tool 200 may be retained within the compartment 300 by frictional engagement. For example, the cleaning tool body 210 or the housing 223 may include an outer surface configured to frictionally engage one or more walls defining the compartment 300. In some embodiments, the outer surface may be compressible, such that insertion of the cleaning tool 200 into the compartment 300 causes deformation of the outer surface, thereby generating a frictional retention force.

Referring to FIG. 2, the compartment 300 of the protective enclosure body 110 is illustrated with one or more retention mechanisms configured to selectively secure the cleaning tool 200 within the compartment 300. In the illustrated embodiment, the compartment 300 includes a pin 500 configured to engage the cleaning tool 200 and prevent unintended removal.

In some embodiments, the pin 500 is configured as an adjustable pin that may be selectively positioned by a user to engage the cleaning tool 200 and increase retention of the cleaning tool within the compartment 300. The pin 500 may be slidably or rotatably mounted to the protective enclosure body 110, such that the position of the pin 500 relative to the compartment opening may be varied.

For example, in one embodiment, the pin 500 may be received within a guide channel formed in the body 110, allowing the pin 500 to translate between a first position in which the pin does not obstruct the compartment opening and a second position in which the pin extends across at least a portion of the opening of the compartment 300. In the second position, the pin 500 engages or overlies a portion of the cleaning tool body 210, thereby increasing retention and resisting removal of the cleaning tool 200.

In some embodiments, the adjustable pin 500 may include a user-actuatable tab or grip portion that enables the user to manually reposition the pin between positions. The pin 500 may be held in a selected position via friction, detents, or a locking feature formed in the guide channel.

In further embodiments, the pin 500 may be configured as a retaining pin movably coupled to the body of the protective enclosure via a latch mechanism. As shown in FIG. 2, the pin 500 may be pivotably or slidably coupled to the protective enclosure body 110, such that the pin is movable between an open position and a retaining position.

In the retaining position, the pin 500 extends across the opening of the compartment 300 and overlies at least a portion of the cleaning tool 200, thereby preventing removal of the cleaning tool from the compartment. The pin 500 may be configured to releasably engage an opposing portion of the protective enclosure body 110. For example, the distal end of the pin 500 may be configured to engage a receiving feature formed on an opposing wall of the compartment 300, such as a recess, slot, or latch interface.

The latch mechanism may include one or more of a resilient tab, snap-fit feature, detent, or biased element that allows the pin 500 to be secured in the retaining position and selectively released upon application of a user force. In this manner, the pin 500 provides a secure but releasable retention mechanism for the cleaning tool 200.

In still further embodiments, the pin 500 may be configured to cooperate with a recess formed in an opposing portion of the protective enclosure body to provide a more defined retention interface. As illustrated in FIG. 2, the pin 500 may be movable between an open position and a closed position. In the closed position, the pin 500 extends across the opening of the compartment 300 and overlies at least a portion of the cleaning tool 200.

The distal end of the pin 500 is configured to be received within a recess formed in an opposing portion of the body 110. The recess may comprise a slot configured to receive the distal end of the pin 500. In some embodiments, the slot includes a retention feature, such as a narrowed region, detent, or resilient clip structure, configured to engage the distal end of the pin.

For example, the distal end of the pin 500 may include a protrusion or enlarged portion configured to snap into the slot and engage the retention feature. The retention feature may include a flexible clip or biased member that temporarily deforms as the distal end of the pin is inserted into the recess and then returns to engage the distal end, thereby retaining the pin in the closed position.

In some embodiments, the interaction between the distal end of the pin 500 and the recess may be analogous to a safety-pin-type engagement, wherein the distal end is guided into the slot and captured by the retention feature to resist unintended disengagement. The pin 500 may be released from the recess by applying a user force sufficient to overcome the retention force of the clip or detent.

In some embodiments, the pin 500 may be formed of a rigid or semi-rigid material, such as a polymer or metal, capable of maintaining its shape while resisting forces applied during removal of the cleaning tool 200. In other embodiments, portions of the pin or latch mechanism may include resilient materials to facilitate snap-fit or clip engagement.

In certain embodiments, multiple pins 500 may be provided, or the pin may be integrated with other retention mechanisms, such as magnetic retention (e.g., magnets 600, 610) or frictional engagement, to provide redundant retention of the cleaning tool 200 within the compartment 300.

It will be appreciated that the specific configurations of the pin 500, latch mechanism, and recess may vary, and that alternative structures capable of performing the described retention functions may be employed without departing from the scope of the present disclosure.

Referring to FIG. 3, the protective enclosure 100 is illustrated with a door 400 formed in the outer surface 130 of the protective enclosure body 110. The door 400 is configured to provide access to the compartment 300, which houses the cleaning tool 200, without requiring removal of the lid 120.

As shown in FIG. 3, the outer surface 130 includes a hinged door 400 movable between an open position and a closed position. In the closed position, the door 400 forms a continuous or substantially continuous portion of the outer surface 130, thereby enclosing the compartment 300 and protecting the cleaning tool 200.

In the open position, the door 400 is displaced away from the outer surface 130, exposing at least a portion of the compartment 300. This exposure permits removal of the cleaning tool 200 from the compartment 300 without requiring disassembly of the protective enclosure 100. In some embodiments, the door 400 may open outwardly, pivot downwardly, or pivot laterally relative to the body 110, depending on design preference.

In the illustrated embodiment, the door 400 is coupled to the protective enclosure body 110 by a hinge assembly. The hinge assembly includes a pivot pin extending through aligned apertures formed in the door 400 and the body 110, thereby permitting rotational movement of the door 400 between the open and closed positions.

In some embodiments, the door 400 further includes a latch configured to releasably engage a corresponding latch feature on the body 110 when the door is in the closed position. For example, the door 400 may include a resilient latch tab that engages a recess or ledge formed in the body 110. Upon application of a user force to the door 400, such as pressing or pulling on a designated portion of the door, the latch disengages from the corresponding latch feature, thereby permitting movement of the door 400 to the open position.

In some embodiments, the latch may include a snap-fit interface, a detent mechanism, or a biased engagement member configured to maintain the door 400 in the closed position until intentionally released by the user.

In certain embodiments, the cleaning tool 200 may be retained within the compartment 300 by magnetic coupling. As illustrated, the cleaning tool 200 may include a first magnet 600, and the compartment 300 may include a second magnet 610 positioned to magnetically couple with the first magnet 600.

The magnetic coupling between the first magnet 600 and the second magnet 610 provides a retention force that resists unintended removal of the cleaning tool 200 from the compartment 300. In some embodiments, the magnetic coupling may be configured such that the cleaning tool 200 remains secured within the compartment during normal handling of the protective enclosure 100, while still permitting intentional removal by a user applying a sufficient pulling force.

Referring to FIG. 4, the compartment 300 of the protective enclosure body 110 is illustrated, showing at least one wall of the compartment 300 and a cleaning tool 200 disposed within a housing 223, the housing 223 being retained within the compartment 300 by frictional engagement and, in some embodiments, magnetic coupling with the lid 120. In the illustrated embodiment, the compartment 300 is defined by one or more walls formed between the outer surface 130 and the inner surface 150, and at least partially defined by the middle surface 140. The walls may include opposing lateral walls, a base wall, and/or a rear wall that collectively define a cavity sized to receive the cleaning tool 200 or the housing 223. In some embodiments, the cleaning tool 200 includes an outer surface dimensioned relative to the compartment 300 to frictionally engage at least one wall of the compartment when inserted. The cleaning tool 200 may be received directly within the compartment 300 or disposed within a cleaning tool supporting housing 223, the housing 223 being configured to frictionally engage the walls of the compartment 300.

In certain embodiments, the outer surface of the cleaning tool 200 or the housing 223 may include surface features such as ribs, ridges, textured regions, or interference-fit regions that increase contact with the walls of the compartment 300, thereby increasing frictional retention. The dimensions of the outer surface may be selected to provide an interference fit with the compartment walls, such that insertion of the cleaning tool 200 requires application of a user force and removal requires overcoming the frictional retention force.

In further embodiments, the outer surface of the cleaning tool 200 or the housing 223 includes a compressible outer surface configured to deform upon insertion into the compartment 300. As shown in FIG. 4, the compressible outer surface may be formed of an elastomeric or resilient material, such as silicone, rubber, foam, or a thermoplastic elastomer.

The compressible outer surface may be dimensioned to have a nominal size slightly larger than a corresponding dimension of the compartment 300, such that insertion of the cleaning tool 200 causes the outer surface to deform against one or more walls of the compartment. This deformation generates a normal force between the outer surface and the walls, resulting in a frictional retention force that retains the cleaning tool within the compartment.

The degree of compression and resulting frictional force may be selected based on the material properties and geometry to ensure that the cleaning tool 200 remains securely retained during normal use, while still being removable by a user applying a reasonable manual force.

As further illustrated in FIG. 4, a portion of the cleaning tool 200 or the housing 223 may protrude from an opening of the compartment 300. The protruding portion may include a first magnet 600. The lid 120 includes a second magnet 610 positioned within a compartment or recess 310 configured to receive the protruding portion of the cleaning tool 200 or housing 223 when the lid 120 is in the closed position. When the lid 120 is closed, the first magnet 600 and the second magnet 610 are brought into proximity and magnetically couple. This magnetic coupling provides a retention force that assists in maintaining the lid 120 in the closed position relative to the protective enclosure body 110.

In some embodiments, the magnetic coupling between the first magnet 600 and the second magnet 610 may supplement or replace other lid retention mechanisms, such as mechanical latches. In other embodiments, the magnetic coupling may be used in combination with frictional engagement of the cleaning tool 200 within the compartment 300, thereby providing multiple retention mechanisms.

In certain embodiments, the magnets 600, 610 may be embedded within the protruding portion of the cleaning tool or housing and within the lid 120, respectively, such that the magnets are not exposed to the exterior environment.

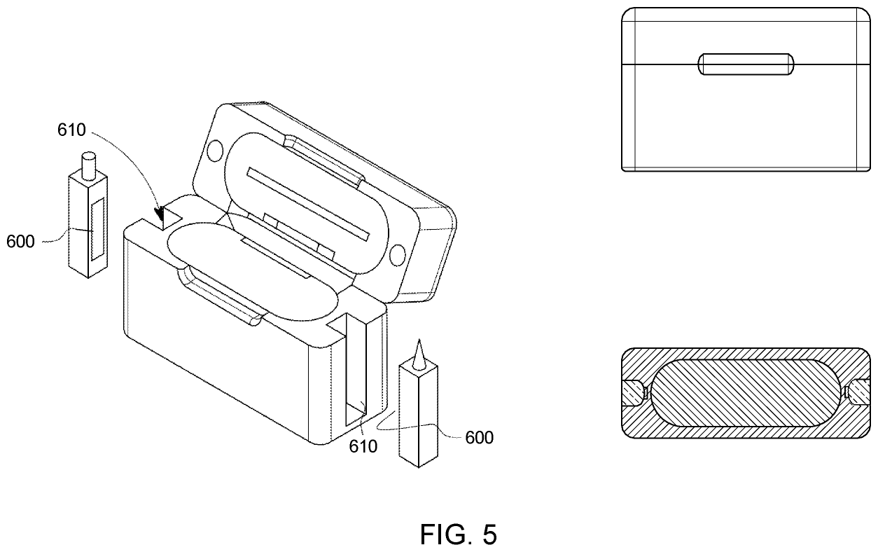

Referring to FIG. 5, an embodiment is illustrated in which the cleaning tool 200 configured to integrate with the protective enclosure body 110. In the illustrated embodiment, the cleaning tool 200 includes a first magnet 600 configured to magnetically couple with a second magnet 610 disposed within the compartment 300 of the protective enclosure body 110. The magnetic coupling between the first magnet 600 and the second magnet 610 serves to retain the cleaning tool 200 within the compartment.

The cleaning tool body 210 is dimensioned and shaped such that, when the cleaning tool 200 is received within the compartment 300, the outer surface 130 is flush and forms a continuous portion of the protective enclosure body 110. In this configuration, the cleaning tool body 210 completes a portion of the enclosure wall structure such that the exterior of the protective enclosure appears substantially continuous. When the cleaning tool 200 is removed from the compartment 300, a corresponding opening is exposed in the outer surface 130 and the middle surface 140 of the protective enclosure body 110, the opening providing access to the compartment 300 and being configured to receive reinsertion of the cleaning tool 200.

In operation, the protective enclosure 100 may be used to store and access the cleaning tool 200 in a controlled and repeatable manner. In some embodiments, a user inserts the cleaning tool 200 into the compartment 300 formed within the protective enclosure body 110, as described with respect to FIGS. 1-5. The cleaning tool 200 may be retained within the compartment 300 by one or more retention mechanisms, including magnetic coupling between a first magnet 600 of the cleaning tool and a second magnet 610 of the compartment, frictional engagement between an outer surface of the cleaning tool 200 or housing 223 and one or more walls defining the compartment, deformation of a compressible outer surface of the cleaning tool or housing, and/or engagement of a pin 500 with a receiving feature formed in the body 110, as previously described.

After insertion, the lid 120 may be moved from an open position to a closed position to enclose the protective enclosure body 110. In some embodiments, a portion of the cleaning tool 200 or housing 223 may protrude from an opening of the compartment 300, and the protruding portion may be received within a corresponding compartment 310 of the lid 120 when the lid is in the closed position.

In certain embodiments, the method further includes magnetically coupling a third magnet 630 of the lid 120 with a fourth magnet 640 of the cleaning tool 200 when the lid is closed. The magnetic coupling between the third magnet 630 and the fourth magnet 640 may be configured to have a greater magnetic coupling force than the magnetic coupling force between the first magnet 600 and the second magnet 610. As a result, upon opening of the lid 120, the cleaning tool 200 is caused to be dislodged from the compartment 300 of the protective enclosure body 110 and to move with or toward the lid 120, thereby facilitating user access to the cleaning tool.

In some embodiments, retention of the cleaning tool 200 within the compartment 300 may be achieved by extending the pin 500 across an opening of the compartment and engaging the pin with a corresponding receiving feature formed in the body 110, as described with respect to FIG. 2. The pin 500 may be selectively disengaged by the user to permit removal of the cleaning tool 200.

In further embodiments, insertion of the cleaning tool 200 into the compartment 300 may cause deformation of a compressible outer surface of the cleaning tool or housing 223, resulting in frictional engagement with one or more walls defining the compartment. This deformation-based frictional engagement provides a retention force that resists unintended removal of the cleaning tool while permitting removal upon application of a user force.

Opening of the lid 120 enables access to the cleaning tool 200, either by exposing the compartment 300 or by presenting the cleaning tool in a position accessible to the user, depending on the specific embodiment. In embodiments including the hinged door 400, the cleaning tool 200 may alternatively be accessed by opening the door while the lid 120 remains in the closed position.

It will be appreciated that the steps described herein may be performed in various sequences and that one or more steps may be omitted or combined depending on the specific configuration of the protective enclosure 100, without departing from the scope of the present disclosure.

It will be appreciated that the various features described herein may be used alone or in combination, and that modifications and variations may be made without departing from the scope of the present disclosure.

What is claimed is:

1. A protective enclosure for a wireless earbud charging case, comprising: a body defining an internal cavity sized and shaped to receive the wireless earbud charging case; a lid movably coupled to the protective enclosure body and configured to transition between an open position and a closed position; an inner surface defining the internal cavity and configured to engage an exterior surface of the wireless earbud charging case; and at least one retention feature configured to secure the wireless earbud charging case within the internal cavity when the lid is in the closed position; wherein the protective enclosure comprises an outer surface, a middle surface, and the inner surface; wherein at least one compartment is formed within the protective enclosure body between the outer surface and the inner surface and is at least partially defined by the middle surface; wherein the compartment houses a removable cleaning tool, the cleaning tool comprising a body and a cleaning tip, the cleaning tip being selected from the group consisting of: (a) a tip formed of a porous or compressible material configured to remove debris from an earbud; and (b) a rigid protruding tip configured to dislodge debris from an earbud.

2. The protective enclosure of claim 1, wherein a portion of the cleaning tool protrudes from an opening of the compartment to enable manual engagement by a user, and wherein the lid includes a compartment configured to receive the protruding portion of the cleaning tool when the lid is in the closed position.

3. The protective enclosure of claim 1, wherein the body of the cleaning tool includes a first magnet, and the compartment includes a second magnet positioned to magnetically couple with the first magnet to secure the cleaning tool within the compartment.

4. The protective enclosure of claim 3, wherein the lid includes a third magnet and the cleaning tip includes a fourth magnet, the third magnet and the fourth magnet being configured to magnetically couple when the protruding portion of the cleaning tool is received within the compartment of the lid, and wherein a magnetic coupling force between the third magnet and the fourth magnet is greater than a magnetic coupling force between the first magnet and the second magnet, such that opening of the lid causes the cleaning tool to be dislodged from the compartment of the protective enclosure body.

5. The protective enclosure of claim 2, wherein the compartment includes an adjustable pin configured to be selectively positioned by a user to engage the cleaning tool and increase retention of the cleaning tool within the compartment.

6. The protective enclosure of claim 2, wherein the compartment includes a retaining pin movably coupled to the body of the protective enclosure via a latch mechanism, the retaining pin being configured to extend across an opening of the compartment and overlie at least a portion of the cleaning tool, and to releasably engage an opposing portion of the body of the protective enclosure to retain the cleaning tool within the compartment.

7. The protective enclosure of claim 2, wherein the compartment includes a pin coupled to the body by a latch, the pin being movable between an open position and a closed position, wherein in the closed position the pin extends across an opening of the compartment and over at least a portion of the cleaning tool, and wherein a distal end of the pin is received within a recess formed in an opposing portion of the body of the protective enclosure, the recess comprising a slot including a retention feature configured to receive the distal end of the pin and to engage a clip to retain the distal end within the recess.

8. The protective enclosure of claim 1, wherein the outer surface includes a hinged door movable between an open position and a closed position, and wherein, in the open position, the hinged door exposes the compartment to permit removal of the cleaning tool from the body of the protective enclosure.

9. The protective enclosure of claim 8, wherein the hinged door is coupled to the body of the protective enclosure by a hinge assembly comprising a pivot pin received within aligned apertures of the hinged door and the body to permit rotational movement of the hinged door between the open position and the closed position, and wherein the hinged door further includes a latch configured to releasably engage a corresponding latch feature on the body of the protective enclosure in the closed position and to disengage from the latch feature upon application of a user force to permit movement of the hinged door to the open position.

10. The protective enclosure of claim 8, wherein the cleaning tool includes a first magnet, and the compartment includes a second magnet configured to magnetically couple with the first magnet to retain the cleaning tool within the compartment.

11. The protective enclosure of claim 8, wherein the hinged door is accessible when the lid is in the closed position, such that the cleaning tool is removable from the compartment while the lid and the body of the protective enclosure remain in the closed position.

12. The protective enclosure of claim 2, wherein the compartment is defined by one or more walls, and wherein the cleaning tool includes an outer surface or is disposed within a housing, wherein the outer surface of the cleaning tool or the housing is configured to frictionally engage at least one of the walls to retain the cleaning tool within the compartment.

13. The protective enclosure of claim 12, wherein the outer surface of the cleaning tool or the housing includes a compressible outer surface configured to deform upon insertion into the compartment and frictionally engage at least one wall defining the compartment to retain the cleaning tool within the compartment.

14. The protective enclosure of claim 12, wherein the protruding portion of the cleaning tool or the housing includes a first magnet, and the lid includes a second magnet positioned within the compartment configured to receive the protruding portion, the first magnet and the second magnet being configured to magnetically couple to retain the lid in the closed position.

15. The protective enclosure of claim 2, wherein the cleaning tool includes a housing having a first magnet configured to magnetically couple with a second magnet disposed within the compartment, wherein the housing of the cleaning tool is flush with and forms a continuous portion of the outer surface and the middle surface of the body of the protective enclosure when the cleaning tool is received within the compartment, and wherein removal of the cleaning tool exposes a corresponding opening in the outer surface and the middle surface of the body of the protective enclosure.

16. A method of storing and accessing a cleaning tool within a protective enclosure for a wireless earbud charging case, the method comprising: inserting a cleaning tool into a compartment formed within a body of the protective enclosure; retaining the cleaning tool within the compartment; closing a lid movably coupled to the body; and opening the lid to enable access to the cleaning tool.

17. The method of claim 16, further comprising positioning a portion of the cleaning tool to protrude from an opening of the compartment, and receiving the protruding portion within a compartment of the lid when the lid is in a closed position.

18. The method of claim 16, further comprising magnetically coupling a first magnet of the cleaning tool with a second magnet of the compartment to retain the cleaning tool within the compartment, magnetically coupling a third magnet of the lid with a fourth magnet of the cleaning tool when the lid is closed, and opening the lid to cause the cleaning tool to be dislodged from the compartment based on a greater magnetic coupling force between the third magnet and the fourth magnet than between the first magnet and the second magnet.

19. The method of claim 16, further comprising retaining the cleaning tool within the compartment by extending a pin across an opening of the compartment and engaging the pin with a receiving feature formed in the body of the protective enclosure.

20. The method of claim 16, further comprising inserting the cleaning tool into the compartment such that an outer surface of the cleaning tool deforms and frictionally engages at least one wall defining the compartment to retain the cleaning tool within the compartment.
